(19) United States
(12) Patent Application Publication
(10) Pub. No.: US 2023/0240343 A1
(43) Pub. Date: Aug. 3, 2023

(54) Versatile Culinary Formulation

(71) Applicant: Michael Vernon Bateman, Spring, TX (US)

(72) Inventor: Michael Vernon Bateman, Spring, TX (US)

(21) Appl. No.: 18/445,063

(22) Filed: Mar. 27, 2023

Related U.S. Application Data
(60) Provisional application No. 63/324,086, filed on Mar. 27, 2022.

(51) Int. Cl. A23L 15/00; A23L 27/14; A21D 2/34; A21D 2/18; A21D 2/36; A23G 9/40; A23G 9/34; A23G 9/42; C12G 3/06; A23L 17/00

(52) U.S. Cl. CPC A23L 15/30; A23L 27/14; A21D 2/34; A21D 2/181; A21D 2/36; A23G 9/40; A23G 9/34; A23G 9/42; C12G 3/06; A23L 17/75

(57) ABSTRACT

A versatile culinary formulation is described. A mixture that includes the culinary formulation is prepared using any of the food preparation methods: cooking, baking, beverage crafting, refrigerating, or freezing. The culinary formulation is used in a plurality of recipes and reduces or eliminates the need for at least one ingredient in each recipe of the plurality of recipes. The flavor and texture of comestibles are enhanced by the culinary formulation. Comestibles prepared from the culinary formulation have a sweet, sour, salty, bitter, or savory taste. Accordingly, each time a comestible is prepared, its taste is the same as long as it is prepared using the culinary formulation. In addition, only the culinary formulation needs to be measured before it is added to a mixture. The ingredients already present in the formulation do not have to be measured or added individually. As a result, preparation of the comestible is more efficient. The culinary formulation may be dry or wet. The dry culinary formulation includes an egg powder, a dairy solid, and an additive. The wet culinary formulation includes an egg, a dairy product, and an additive. Furthermore, the additive is at least one of a flavor enhancer or a texture enhancer to improve the flavor or texture of the comestible, an anti-clumping agent or colorant to improve the appearance of the dry or wet culinary formulation, or a preservative to extend the shelf life of the dry or wet culinary formulation.

### TECHNICAL FIELD

The present disclosure relates generally to techniques for food preparation. More specifically, the present techniques relate to a culinary formulation that can be substituted for at least one ingredient in a wide variety of recipes.

### BACKGROUND ART

Grocery store shelves are replete with mixes composed of two or more ingredients. These mixes are prepared for consumption using only one method. For example, soup mixes are prepared by cooking; bread mixes are prepared by baking; drink mixes are prepared by beverage crafting; gelatin dessert mixes are prepared by refrigerating; and ice cream mixes are prepared by freezing. Furthermore, only one food product is prepared when such a mix is used. For example, soup mixes, bread mixes, drink mixes, gelatin dessert mixes, and ice cream mixes are used to prepare soups, breads, drinks, gelatin desserts, and ice cream, respectively. In short, a single method is used to prepare a single comestible. A mix that makes food preparation more flexible is needed.

### BRIEF DESCRIPTION OF THE DRAWINGS

FIGS. 1A and 1B are a table that lists the food items that have been prepared using the culinary formulation.

### DESCRIPTION OF THE EMBODIMENTS

The culinary formulation disclosed herein is an improvement over the conventional mixes described above. Its use provides the flexibility that is lacking when conventional mixes are used. For example, a mixture that includes the culinary formulation may be prepared using any of the food preparation methods: cooking, baking, beverage crafting, refrigerating, and freezing. Furthermore, the culinary formulation is very versatile and may be used in a plurality of recipes.

In addition to flexibility, there are other advantages to be gained by using the culinary formulation. For example, the culinary formulation may reduce or eliminate the need for at least one ingredient in each recipe of the plurality of recipes in which the formulation can be used. Recipes for crepes, donuts, French toast, ice cream, waffles, or the like require eggs. However, these comestibles have been prepared using the culinary formulation and no eggs were needed.

The culinary formulation also enhances the flavor and texture of comestibles. The flavor is enhanced in two ways. The culinary formulation adds flavor and brings out the flavors of other ingredients. As to texture, use of the culinary formulation makes creamy comestibles even creamier. This is just one example of a texture that is improved using the culinary formulation. Other textures of a comestible are improved by adding texture enhancers to the culinary formulation as discussed below.

The comestibles prepared using the culinary formulation have a wide variety of tastes. The variety is produced by adding the culinary formulation to a large assortment of recipes. The comestibles that result are sweet, sour, salty, bitter, or savory. This list of tastes is noteworthy because it includes all the types of taste perceptible by the tongue.

When the culinary formulation is added to a recipe, the comestible that results has a particular taste. If the culinary formulation is added to a different recipe, the taste of the comestible will be different. The recipe changes, but the composition of the culinary formulation remains the same. Consistency is another advantage of the formulation. The taste of a comestible does not change as long as the culinary formulation is used in the preparation of the comestible. A user of the culinary formulation need not be concerned that the taste of a comestible will change each time he or she prepares the comestible.

Convenience is another advantage to be gained by using the culinary formulation. For example, ice cream may be prepared by mixing the culinary formulation with milk and cream, stirring the mixture, and pouring it into an ice cream maker. No eggs are needed and no cooking is involved. In addition, only the culinary formulation needs to be measured before it is added to a mixture. The ingredients already present in the formulation do not have to be measured or added individually. As a result, preparation times are shortened. The use of the culinary formulation improves the efficiency of a user and he or she spends less time in the kitchen.

The subject matter disclosed herein relates to techniques for preparing and using a culinary formulation. For example, a dry culinary formulation may include an egg powder, a dairy solid, and an additive. The dry culinary formulation may provide the advantages discussed above. Specifically, a comestible may be prepared by cooking, baking, beverage crafting, refrigerating, or freezing a mixture that includes the dry culinary formulation. In short, the dry formulation may be used with any of the food preparation methods. This is just one example of the versatility of the dry culinary formulation. Additionally, a comestible prepared from the dry culinary formulation may be sweet, sour, salty, bitter, or savory. This list includes all the tastes perceptible by the tongue. This is a further example of the versatility of the dry culinary formulation. Moreover, the dry culinary formulation may be used in a plurality of recipes and may reduce or eliminate the need for at least one ingredient in each recipe of the plurality of recipes. This is yet another example of the versatility of the dry culinary formulation.

The examples of the versatility of the dry culinary formulation are not limited to those already discussed. In particular, the dry culinary formulation may contain various additives in any number of combinations and concentrations. For example, the additive may be a flavor enhancer that improves the flavor of a comestible. The flavor enhancer may include at least one of sugar, ground cinnamon, ground nutmeg, vanilla powder, strawberry powder, coconut powder, coffee powder, mint powder, cocoa, allspice, salt, pepper, or the like. The number of combinations of these flavor enhancers may improve the flavor of the comestible in multiple ways. Furthermore, the concentrations of the flavor enhancers in the dry culinary formulation may vary considerably. Consequently, the number of improvements to the flavor of the comestible may be inestimable.

The additive may be a texture enhancer that improves the texture of the comestible. The texture enhancer may be at least one of powdered milk, powdered cream, nuts, toasted corn flakes, oatmeal, breadcrumbs, dried potato sticks, seeds, or the like. The number of improvements to the texture of the comestible may be inestimable for at least the same reasons that the number of improvements to the flavor of the comestible is inestimable.

Additives may be included in the dry culinary formulation for reasons other than improving the flavor or texture of the comestible. For example, to improve the appearance of the dry culinary formulation, the additive may be an anti-clumping agent or a colorant. In addition, the additive may be a preservative to extend the shelf life of the dry culinary formulation.

The various ingredients of the dry culinary formulation may be combined to form powders, crystals, granules, pellets, or the like depending upon what is needed in a recipe for a comestible. Once again, the versatility of the dry culinary formulation is evident.

There are advantages to be gained during preparation of the dry culinary formulation. For example, steps such as homogenization, pasteurization, or the like may be eliminated. As a result, the time needed to produce a batch of the dry culinary formulation is shortened and more of the dry culinary preparation may be produced.

The preparation process may result in a dry culinary formulation having the following composition:
20.0-34.0 wt % Egg Powder
32.0-55.0 wt % Sugar
18.0-24.0 wt % Dairy Solids
0.9-7.0 wt % Cinnamon
3.0-5.0 wt % Vanilla Powder
0.4-0.7 wt % Salt

It is this composition of the dry culinary formulation that may be used in a plurality of recipes to prepare a plurality of comestibles. Examples 1-7 (below) are just a few of the many comestibles that may be prepared using the dry culinary formulation.

The subject matter disclosed herein also relates to techniques for preparing and using a wet culinary formulation. For example, the wet culinary formulation may include an egg, a dairy product, and an additive. Like its dry counterpart, the wet culinary formulation may provide the advantages discussed above. In particular, the wet culinary formulation is also very versatile as demonstrated by the following examples. A comestible may be prepared by cooking, baking, beverage crafting, refrigerating, or freezing a mixture that includes the wet culinary formulation. In short, the wet culinary formulation is versatile in that it may be used with any of the food preparation methods. Additionally, a comestible prepared from the wet culinary formulation may taste sweet, sour, salty, bitter, or savory. This list includes all of the tastes perceptible by the tongue and provides another example of the versatility of the wet culinary formulation. Moreover, the wet culinary formulation may be used in a plurality of recipes and may reduce or eliminate the need for at least one ingredient in each recipe of the plurality of recipes. Like its dry counterpart, the versatility of the wet culinary formulation is evident.

The wet culinary formulation may contain a number of additives. For example, the additive may be a flavor enhancer that improves the flavor of a comestible. The flavor enhancer may be at least one of an extract, butter, coffee, fruit juice, vegetable juice, or the like. Example extracts may include vanilla extract, almond extract, cherry extract, peppermint extract, or the like. Vanilla extract is an especially good flavor enhancer. It is known to bring out many flavors in a comestible. Example fruit juices may include lemon juice, orange juice, apple juice, or the like. Example vegetable juices may include carrot juice, beet juice, tomato juice, or the like.

The wet culinary formulation may contain the flavor enhancers in any number of combinations and concentrations. The number of combinations of the flavor enhancers may improve the flavor of a comestible in multiple ways. Furthermore, the concentrations of the flavor enhancers in the wet culinary formulation may vary considerably. Consequently, the number of improvements to the flavor of the comestible may be inestimable.

Another example of an additive may be a texture enhancer which is used to improve the texture of a comestible. The texture enhancer may be at least one of an egg, milk, heavy cream, sour cream, crème fraîche, cream cheese, yogurt or the like. Like the number of improvements to the flavor of a comestible, the number of improvements to the texture of the comestible may be inestimable.

Like its dry counterpart, additives may be included in the wet culinary formulation for reasons other than improving the flavor or texture of a comestible. For example, the additive may be an anti-clumping agent to prevent aggregation of any dry constituents in the wet culinary formulation. The appearance of the wet formulation is thereby improved. Including a colorant may also improve the appearance of the wet formulation.

The shelf life of the wet culinary formulation is limited by the shelf life of the milk contained therein. To extend its shelf life, the wet formulation may include a preservative. The shelf life may be extended even longer if homogenization or a similar process is included in the preparation of the wet formulation. The length of time added to the shelf life depends upon the method used to implement the homogenization or similar process.

The ingredients of the wet culinary formulation may be combined to produce a liquid, syrup, oil, gel, or the like. The form of the wet formulation used to prepare a comestible is dictated by the recipe. More comestibles may be prepared because the wet formulation can assume different forms. This is yet another example of the versatility of the wet culinary formulation.

The composition of the wet culinary formulation is:
6.0-10.0 vol % Egg
6.0-17.0 vol % Sugar
0.2-1.0 vol % Cinnamon
1.0-2.0 vol % Vanilla
37.0-52.0 vol % Milk
23.0-43.0 vol % Heavy Cream
Dash of Salt

To prepare the wet culinary formulation, beat eggs, add dry ingredients, and mix. Add vanilla, milk, and heavy cream in that order and mix after addition of each ingredient.

It is the above composition of the wet culinary formulation that may be used in a plurality of recipes to prepare a plurality of comestibles. Examples 8-12 (below) are just a few of the many comestibles that may be prepared using the wet culinary formulation.

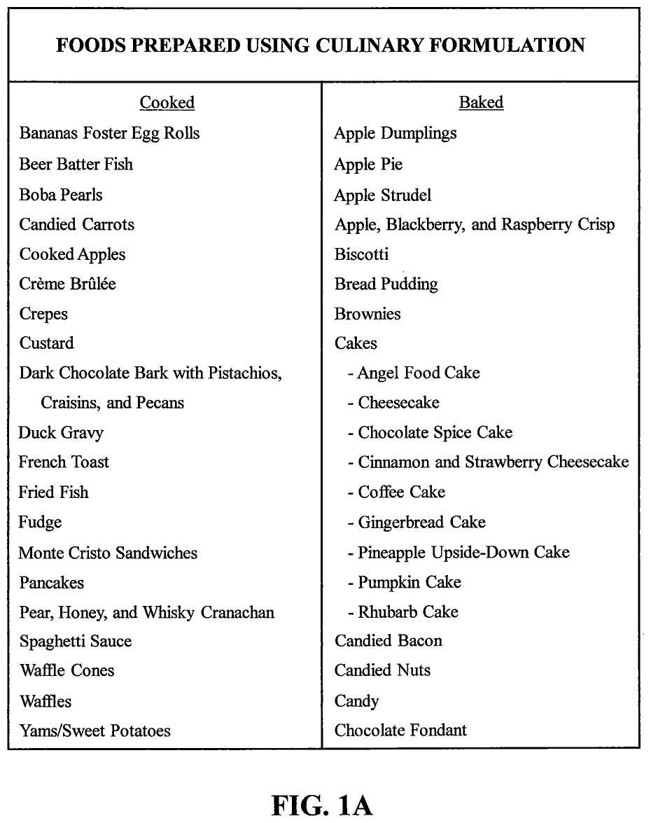

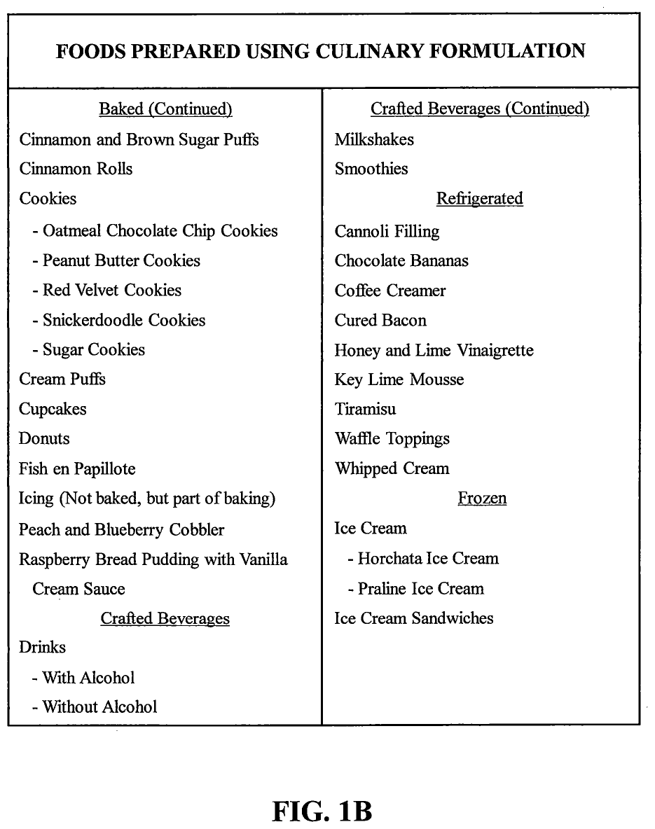

FIGS. 1A and 1B list the foods that have been prepared using the dry and wet culinary formulations. The table in FIGS. 1A and 1B is divided into five sections. There is a section for each of the preparation methods used: cooked, baked, crafted beverage, refrigerated, or frozen. These represent the major categories of food preparation methods. For example, cooking encompasses grilling, barbecuing, smoking, braising, sautéing, frying, stir-frying, poaching, steaming, boiling, simmering, blanching, or the like. Baking encompasses roasting, en papillote, or the like. Beverage crafting encompasses fermenting, cocktail mixing, wine making, brewing, distilling, or the like.

In each section of the table, there is a list of foods prepared by the preparation method identified in the heading. For example, under the heading “Cooked,” there is a list of the foods prepared by cooking. Under the headings “Baked,” “Crafted Beverages,” “Refrigerated,” and “Frozen,” there are lists of the foods prepared by baking, crafting beverages, refrigerating, and freezing, respectively. Each food is categorized by the primary method used in its preparation.

FIGS. 1A and 1B are a good example of the versatility of the culinary formulation. Under each heading, there is a variety of comestibles. Each comestible has at least one of the tastes perceptible by the tongue: sweet, sour, salty, bitter, or savory. Brownies, cakes, candy, cookies, and donuts are just a few of the foods that are sweet. Cured bacon and beer batter fish are examples of foods that are salty. Monte Cristo sandwiches and fish en papillote are examples of foods that are savory. Even texture enhancers can add taste to comestibles prepared using the culinary formulation. In addition to improving texture, yogurt can give comestibles a sour taste. Other texture enhancers such as coffee and cocoa can result in a bitter taste.

FIGS. 1A and 1B represent only a small fraction of the recipes that can be prepared using the culinary formulation. For example, the culinary formulation could be used to prepare over 200 varieties of cookies. Furthermore, cookies are just one type of baked food. The total number of recipes that can be prepared from the culinary formulation is inestimable for at least three reasons. First, many foods such as sweet potatoes can be prepared from different recipes that require the same preparation method. Second, numerous foods can be prepared using different preparation methods. For example, meats can be prepared by cooking or baking. Third, ethnic dishes from around the world add an almost limitless number of comestibles to the total number of comestibles that can be prepared using the culinary formulation.

### Example 1

Crepes were prepared using the dry culinary formulation. The ingredients and instructions are given below.
1 cup all-purpose flour
1 cup dry culinary formulation
2 cups whole milk
2 eggs
1½ tablespoons sugar
½ teaspoon salt
3 tablespoons butter

Melt butter and cool to room temperature. Add eggs to melted butter and mix. Add egg and butter mixture to dry ingredients and mix well. Cool batter in refrigerator for 30 minutes. Spread a thin layer of batter in pan and cook for 3 minutes or until slightly browned. Flip and cook for 1 minute or until slightly browned.

### Example 2

Ice cream was prepared using the dry culinary formulation. The ingredients and instructions are given below.
6 ounces dry culinary formulation
1¼ cups heavy cream
1¼ cups milk

Add dry culinary formulation to mixture of heavy cream and milk and mix well. Refrigerate custard. Add refrigerated custard to ice cream maker. Follow directions for using ice cream maker to make ice cream. Freeze finished product.

### Example 3

French toast was prepared using the dry culinary formulation. The ingredients and instructions are given below.
8 tablespoons dry culinary formulation
1 cup milk

Mix ingredients. Dip bread into mixture and fry.

### Example 4

A beverage was prepared using the dry culinary formulation. The ingredients and instructions are given below.
3 tablespoons dry culinary formulation
3 ounces milk
1½ ounces (1 shot) dark rum (optional)

Mix well.

### Example 5

Waffles were prepared using the dry culinary formulation. The ingredients and instructions are given below.
3 cups milk
2 tablespoons butter
3 tablespoons sugar
1 cup dry culinary formulation
2 tablespoons vanilla
2 tablespoons cinnamon
¼ tablespoon nutmeg
¼ teaspoon salt
3 cups flour
2 teaspoons baking powder

Mix sugar and vanilla. Melt butter and add to sugar and vanilla mixture. Mix well. Combine dry ingredients and add to wet ingredients. Mix well. Add batter to waffle maker. Follow directions for using waffle maker to make waffles.

### Example 6

Buttermilk donuts were prepared using the dry culinary formulation. The ingredients and instructions are given below.
¾ cup buttermilk
2 tablespoons vegetable oil
2 ounces brown sugar
3 ounces dry culinary powder
¼ teaspoon salt
5 ounces flour
½ teaspoon baking soda

Combine dry ingredients and mix well. Combine vegetable oil and buttermilk and mix well. Add wet ingredients to dry ingredients and mix well. Fill donut mold with batter until half full. Bake at 325° F. for 16 minutes.

### Example 7

Beer batter fish was prepared using the dry culinary formulation. The ingredients and instructions are given below.
1 cup all-purpose flour
½ cup rice flour
½ cup dry culinary formulation
1 teaspoon salt
½ teaspoon pepper
1 tablespoon garlic powder
1 tablespoon paprika
1 tablespoon onion powder
1 egg
2½ cups vanilla porter beer

Combine dry ingredients. Add beer and mix. Add egg. Chill batter if necessary. Pat fish dry and batter. Fry battered fish at 375-400° F. until golden brown. Cool fish on rack.

### Example 8

Coffee cake was prepared using the wet culinary formulation. The ingredients and instructions are given below.
3 cups all-purpose flour
2¼ cups sugar
¾ teaspoon baking powder
½ teaspoon baking soda
½ teaspoon kosher salt
1 cup unsalted butter, softened
1 cup sour cream
¼ cup wet culinary formulation
4 large eggs
1 tablespoon vanilla extract

In mixer bowl, add flour, sugar, baking powder, baking soda, and kosher salt. Combine using stand mixer on low speed. Add softened butter and beat on medium-low speed for 2-3 minutes. Combine sour cream, wet culinary formulation, eggs, and vanilla. Add mixture to dry ingredients. Beat batter on medium speed until smooth. Spread batter in pan. Bake for 55 minutes at 350° F. Cool on rack until cake comes to room temperature.

### Example 9

Ice cream was prepared using the wet culinary formulation. The ingredients and instructions are given below.

Add wet culinary formulation to ice cream maker. Follow directions for using ice cream maker to make ice cream. Freeze finished product.

### Example 10

French toast was prepared using the wet culinary formulation. The ingredients and instructions are given below.

Add egg to wet culinary formulation and mix. Dip bread into mixture and fry.

### Example 11

A beverage was prepared using the wet culinary formulation. The ingredients and instructions are given below.

Use wet culinary formulation as is.

### Example 12

Waffles were prepared using the wet culinary formulation. The ingredients and instructions are given below.

Combine egg and wet culinary formulation and mix. Add batter to waffle maker. Follow directions for using waffle maker to make waffles.

Various examples or embodiments have been presented in this disclosure. Reference to “examples” indicates that a particular feature is included in at least some examples, but not necessarily in all examples, of the present techniques. The various occurrences of “examples” are not necessarily referring to the same examples.

Not all features described and illustrated herein need to be included in a particular example or examples. If the specification states a feature “may,” “can,” or “could” be included, that particular feature is not required to be included. If the specification or claims refer to “a” or “an” element, that does not mean there is only one of the element. Furthermore, as used herein, “or” is inclusive. For example, the phrase “A or B” means “A,” “B,” or “A and B.”

Some examples have been described by referring to particular implementations.

However, other implementations are possible. The implementations of the present techniques are not limited to those disclosed herein. Additionally, the features described herein need not be sequenced in the particular way described. Other sequences are possible.

The present techniques are not restricted to the particular details described herein. Those skilled in the art having the benefit of this disclosure will appreciate that many other variations of the foregoing descriptions are possible and remain within the scope of the present techniques. Accordingly, the scope of the present techniques is defined by the following claims and any amendments thereto.

What is claimed is:

1. A dry culinary formulation, comprising:
an egg powder;
a dairy solid; and
an additive,
wherein a comestible is prepared by any one of cooking, baking, beverage crafting, refrigerating, or freezing a mixture that includes the dry culinary formulation.

2. The dry culinary formulation of claim 1, wherein the dry culinary formulation is used in a plurality of recipes and reduces or eliminates the need for at least one ingredient in each recipe of the plurality of recipes.

3. The dry culinary formulation of claim 1, wherein a form of the dry culinary formulation comprises a powder, a crystal, a granule, or a pellet.

4. The dry culinary formulation of claim 1, wherein the additive comprises a flavor enhancer to improve a flavor of the comestible.

5. The dry culinary formulation of claim 4, wherein the flavor enhancer comprises at least one of sugar, ground cinnamon, ground nutmeg, vanilla powder, strawberry powder, coconut powder, coffee powder, mint powder, cocoa, allspice, salt, or pepper.

6. The dry culinary formulation of claim 1, wherein the additive comprises a texture enhancer to improve a texture of the comestible.

7. The dry culinary formulation of claim 6, wherein the texture enhancer comprises at least one of powdered milk, powdered cream, nuts, toasted corn flakes, oatmeal, breadcrumbs, dried potato sticks, or seeds.

8. The dry culinary formulation of claim 1, wherein the additive comprises an anti-clumping agent or a colorant to improve an appearance of the dry culinary formulation.

9. The dry culinary formulation of claim 1, wherein the additive comprises a preservative to extend a shelf life of the dry culinary formulation.

10. The dry culinary formulation of claim 1, wherein the dry culinary formulation is used to prepare comestibles that taste sweet, sour, salty, bitter, or savory.

11. The dry culinary formulation of claim 1, wherein at least homogenization and pasteurization are eliminated from a process for preparing the dry culinary formulation.

12. A wet culinary formulation, comprising:
an egg;
a dairy product; and
an additive,
wherein a comestible is prepared by any one of cooking, baking, beverage crafting, refrigerating, or freezing a mixture that includes the wet culinary formulation.

13. The wet culinary formulation of claim 12, wherein the wet culinary formulation is used in a plurality of recipes and reduces or eliminates the need for at least one ingredient in each recipe of the plurality of recipes.

14. The wet culinary formulation of claim 12, wherein a form of the wet culinary formulation comprises a liquid, a syrup, an oil, or a gel.

15. The wet culinary formulation of claim 12, wherein the additive comprises a flavor enhancer to improve a flavor of the comestible.

16. The wet culinary formulation of claim 15, wherein the flavor enhancer comprises at least one of an extract, butter, coffee, fruit juice, or vegetable juice.

17. The wet culinary formulation of claim 12, wherein the additive comprises a texture enhancer to improve a texture of the comestible.

18. The wet culinary formulation of claim 17, wherein the texture enhancer comprises at least one of an egg, milk, heavy cream, sour cream, crème fraîche, cream cheese, or yogurt.

19. The wet culinary formulation of claim 12, wherein the additive comprises an anti-clumping agent or a colorant to improve an appearance of the wet culinary formulation and wherein the additive comprises a preservative to extend a shelf life of the wet culinary formulation.

20. The wet culinary formulation of claim 12, wherein the wet culinary formulation is used to prepare comestibles that taste sweet, sour, salty, bitter, or savory.
